(19) United States
(12) Patent Application Publication
(10) Pub. No.: US 2023/0291694 A1
(43) Pub. Date: Sep. 14, 2023

(54) FURTHER IMPROVED DATA TRANSPORT METHODS

(71) Applicant: BRITISH TELECOMMUNICATIONS PUBLIC LIMITED COMPANY, London (GB)

(72) Inventors: Evandro PIOLI MORO, London (GB); Mohammad ZOUALFAGHARI, London (GB)

(21) Appl. No.: 18/040,487

(22) PCT Filed: Jul. 20, 2021
(86) PCT No.: PCT/EP2021/070293

§ 371 Date: Feb. 3, 2023

(30) Foreign Application Priority Data
Aug. 5, 2020 (GB) 2012174.5

(51) Int. Cl. H04L 47/36; G06Q 20/38

(52) U.S. Cl. CPC H04L 47/365; G06Q 20/389

(57) ABSTRACT

There is herein described a method of transmitting a data packet from a first node to a second node in accordance with a predetermined arrangement between a first party and a second party, the method including receiving information relating to a characteristic of the data packet at a smart contract using the received information relating to a characteristic of the data packet to determine a location at which a change to the data packet occurred.

### PRIORITY CLAIM

The present application is a National Phase entry of PCT Application No. PCT/EP2021/070293, filed Jul. 20, 2021, which claims priority from GB Patent Application No. 2012174.5, filed Aug. 5, 2020, each of which is hereby fully incorporated herein by reference.

### TECHNICAL FIELD

The present disclosure relates to distributed ledger technology and in particular to ensuring that distributed ledgers are accurately updated in relation to transactions involving data packets. Such transactions may arise in internet of things systems.

### BACKGROUND

Internet of things systems typically use sensors to measure how the value of certain quantities vary over time. This sensor data may then be sold to a customer who is interested in the sensed data. In the electrical power sector, for example, the way that power consumption varies over time in a typical company or industry may be of interest to a customer, e.g. a company operating in that sector. A vendor may therefore sell the data to the customer and the transaction may be recorded using Distributed Ledger Technology (DLT). The DLT determines whether the transaction has met the requirements of the contract that exists between the vendor and customer in relation to the data.

If it is determined that the requirements of the contract have been met, the DLT authorises payment from the customer's account to the vendor's account. Using a DLT for this has benefits such as immutability and the fact that the record is distributed. However, if the vendor and the customer disagree on what precisely the vendor sent the customer, it is difficult to determine who is correct.

### SUMMARY

It would be desirable to overcome and/or mitigate some or all of the above-mentioned and/or other drawbacks.

According to a first aspect of the disclosure there is provided a method of transmitting a data packet from a first node to a second node in accordance with a predetermined arrangement between a first party and a second party; the method comprising: receiving information relating to a characteristic of the data packet at a smart contract; using the received information relating to a characteristic of the data packet to determine a location at which a change to the data packet occurred.

The method may further comprise performing a comparison of the received information relating to a characteristic of the data packet to the predetermined arrangement. Performing a comparison may be performed by the smart contract. The method may further comprise using the outcome of the comparison to determine the location at which a change to the data packet occurred. Determining a location may be performed by the smart contract.

The method may further comprise receiving further information relating to the characteristic of the data packet at the smart contract. The further information relating to the characteristic of the data packet may come from a different location on the transmission path of the data packet to the information relating to the characteristic of the data packet. The method may further comprise comparing the information relating to a characteristic of the data packet with the further information relating to a characteristic of the data packet. The smart contract may receive further information relating to the characteristic of the data packet from multiple locations. The multiple locations may comprise nodes.

The method may further comprise taking one or more remedial actions in relation to the location at which it is determined that a change to the data packet occurred. One remedial action may comprise communicating with the location at which it is determined that a change to the data packet occurred. This location may be a node on the transmission path of the data packet. A remedial action may comprise imposing a penalty on that node, which may be a financial penalty.

The method may further comprise using the outcome of the comparison of the received information relating to a characteristic of the data packet to the predetermined arrangement to determine whether to impose a penalty on either the first party or the second party. Determining whether to impose a penalty may be performed by a smart contract. A penalty may be imposed if there is a difference between a value of the received information relating to a characteristic of the data packet and a corresponding value in the predetermined arrangement. The penalty may be imposed if this difference exceeds a threshold. The penalty may be a financial penalty. The penalty may be imposed by an enforcement module. The enforcement module may be programmable and may be an Application Programming Interface (API).

The first party may be associated with the first node. The second party may be associated with the second node. The first party may produce electricity and may produce solar or wind generated electricity.

The information relating to a characteristic of the data packet may be transmitted to the smart contract by the first node and/or the second node. The data packet may be transmitted from the first node to the second node via a telecommunications network. The telecommunications network may comprise one or more further nodes. Alternatively or in addition, transmitting information relating to a characteristic of the data packet to a smart contract may be performed by the one or more further nodes.

The information relating to a characteristic of the data packet may be the size of the data packet. This information may be obtained from one or more data monitors prior to being received by the smart contract. The information may be received by the smart contract from the one or more data monitors. The one or more data monitors may be independent of the first and second nodes. The one or more data monitors may be blockchain components. A data monitor may be located in the vicinity of the first node. A further data monitor may be located in the vicinity of the second node. The one or more data monitors may comprise one or more packet size inspectors.

In some embodiments, one or more of the data monitors are under the control of the first node. In such embodiments the first node may be a trusted node.

The predetermined arrangement may be a Service-Level Agreement (SLA). The SLA may be a contract requiring the first node to transmit the data packet to the second node in return for financial payment.

The smart contract may store the transmitted information relating to a characteristic of the data packet on a blockchain associated with a DLT (Distributed Ledger Technology). This may use convolutive algorithms which may comprise collective hashing computations and/or API calls to store the information. The method may further comprise obtaining this stored information and using it to resolve disputes between parties to the transaction.

The first node may controlled by a supplier of products and/or services. The second node may be a controlled by a consumer of products and/or services.

The data packet may comprise information relating to electrical power consumption and may comprise a measure of the variability with time of a rate of power consumption. The first and second nodes and/or the one or more further node may define component parts of respective Internet of Things platforms.

The smart contract may write to the blockchain that the data packet has been transmitted from the first node to the second node. This may involve writing to the blockchain some or all of: the identity of the first and second node (i.e. the parties to the transaction), the type of data packet, the size of the data packet on transmission from the first node, the size of the data packet when received at the second node, the time of transmission of the data packet, the price of the data packet.

The DLT may comprise two or more nodes. In some examples the DLT comprises or more nodes, such as 50 or more nodes.

According to a second aspect of the disclosure there is provided a system for transmitting a data packet in accordance with a predetermined arrangement between a first party and a second party; the system comprising: a first node, a second node, the first node being adapted to transmit the data packet to the second node, a smart contract adapted to receive information relating to a characteristic of the data packet and to use the received information relating to a characteristic of the data packet to determine a location at which a change to the data packet occurred.

The features defined in relation to the first aspect of the disclosure are also applicable to the second aspect of the disclosure.

### BRIEF DESCRIPTION OF THE DRAWINGS

A specific embodiment of the disclosure will now be described in detail, for illustration only, and with reference to the appended drawings, in which:

FIG. 1 is a schematic view of a known arrangement for IoT transactions using DLT.

FIG. 2 is a schematic view of an arrangement according to an embodiment of the disclosure.

FIG. 3 is a schematic view of a further arrangement according to an embodiment of the disclosure.

FIG. 4 is a schematic view of a further arrangement according to an embodiment of the disclosure.

FIG. 5 is a schematic view of a further arrangement according to an embodiment of the disclosure.

### DETAILED DESCRIPTION

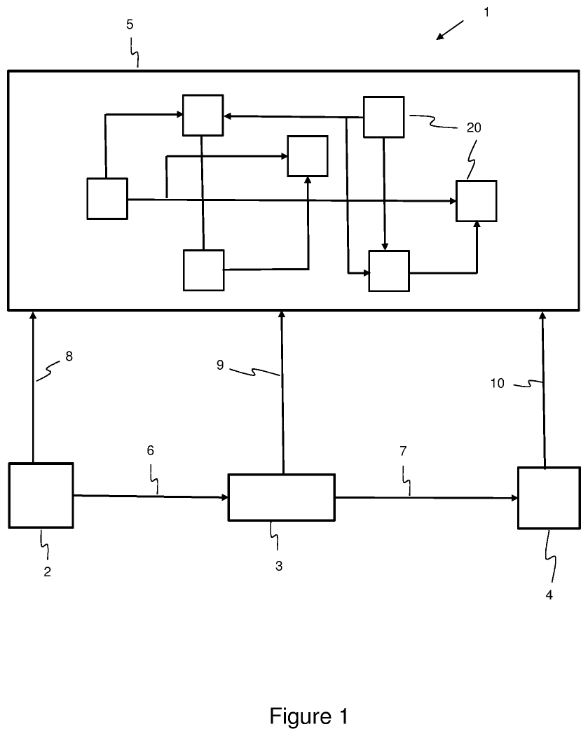

FIG. 1 shows a known internet of things arrangement for performing a data transaction using blockchain. The arrangement is shown generally at 1. A data publisher 2 has a contract with a data receiver 4 to transmit a data package to the data receiver 4 over a telecommunications network 3, in return for financial payment. The contract is a Service-level Agreement (SLA). The data package is 100 MB in size. Each of the three parties is able to communicate with a Distributed Ledger Technology (DLT) network 5. The DLT 5 comprises multiple nodes 20 which together form a distributed ledger for the purposes of blockchain.

The transaction proceeds as follows. The data publisher 2 transmits the package over the network 3 to the receiver 4. The publisher 2 updates the DLT with the following information: (i) the fact that the package has been transmitted; (ii) the size of the package; and (iii) the destination of the package (i.e. the receiver 4). The receiver 4 receives the package and updates the DLT 5 with the following information: (i) the fact that it has received the package; (ii) the size of the package; and (iii) the origin of the package (i.e. the publisher 2). The blockchain is then updated using this information. If the requirements of the contract are fulfilled, the publisher 2 makes the payment to the receiver 4.

Such a system enjoys the benefits of blockchain technology. One such benefit is that, once the information has been written to the blockchain, any subsequent alterations to the information are easily noticeable as they will noticeably affect all subsequent blocks. It is therefore easy to detect if the data is changed fraudulently. However, the publisher 2 and receiver 4 may disagree on the size of the data package that was sent/received. For example, the publisher 2 may write to the blockchain that it sent a 100 MB package to the receiver 4. The receiver 4 may write to the blockchain that it received an 80 MB package from the publisher 2. Such a disagreement is hard to resolve.

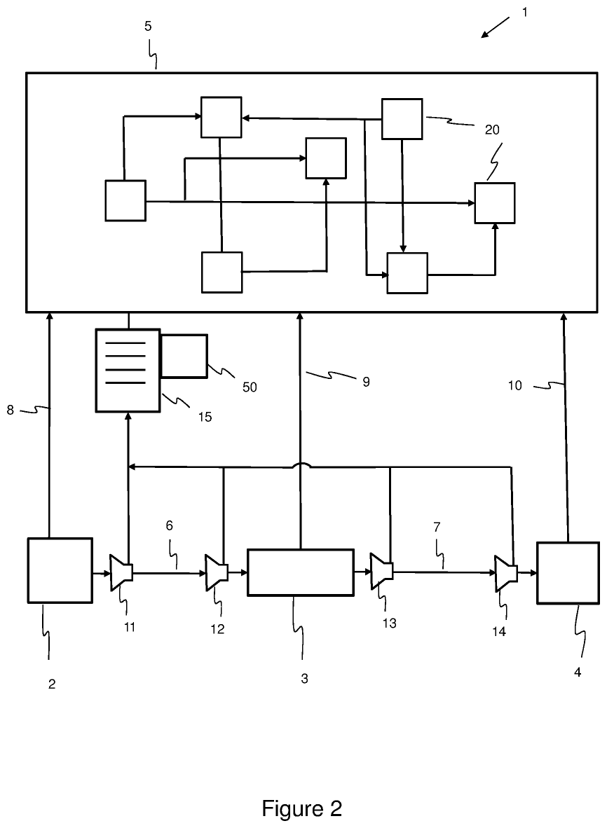

FIG. 2 shows an arrangement according to the disclosure. In the arrangement, a data monitor 11 is provided at the output of the publisher 2, a further data monitor 12 is provided at the input to the telecomms network 3. A further data monitor 13 is provided at the output to the telecomms network 3. And a further data monitor 14 is provided at the input of the receiver 4. The data monitors measure the size of the data package at these locations within the arrangement. Each of the data monitors are simple data package inspectors.

A smart contract 15 is provided. A smart contract, as is familiar to those skilled in the art, is a piece of code that is executed in a decentralised fashion within the virtual machine of each node 20 in the DLT network 5. The smart contract 15 interfaces with each of the data monitors 11,12,13,14. The smart contract 15 contains all the terms of the SLA. Such terms are, inter alia, the size of the data package, the origin of the data package, the destination of the data package and the agreed price the receiver 4 will pay the publisher 2 for the data package.

When the publisher 2 transmits the data package, the data monitor 11 at its output measures the size of the package and transmits that information to the smart contract 15. As the package arrives at the telecommunications network 3, the data monitor 12 associated with input to the network 3 measures the size of the data package. The data monitor 12 then transmits the measured size to the smart contract 15. As the package is output from the telecomms network it is measured by data monitor 13, which transmits the outcome of the measurement to the smart contract 15. The data package then passes to the receiver 4. When the package arrives at the receiver 4, the data monitor 14 associated with the receiver 4 measures the size of the data package. The data monitor 14 then transmits the measured size to the smart contract 15.

The smart contract 15 compares the measured size it has received from each of the data monitors to the size that is stipulated by the SLA. If each of the measurements sizes are within a given tolerance of the size stipulated by the SLA, the smart contract deems the SLA to be fulfilled and the smart contract 15 writes the transaction to the blockchain. This is done by each of the DLT nodes 20 in the DLT network 5 updating their respective virtual machines to create an immutable record. This is achieved by processing the data using convolutive algorithms, such as collective hashing computations, API calls to store the data and within the blockchain processing to be securely stored using custom-built smart contracts or within timestamped transactions. The immutability is an inherent characteristic of blockchains which is assured by running unique mathematical operations in blocks and storing them as fields on future blocks. The smart contract then causes funds to be transferred by the receiver 4 to the publisher 2. The amount of the transfer is that stipulated in the SLA as the price of the data package.

If the comparison performed by the smart contract shows that the measured sizes do not lie within a tolerance of the size stipulated in the SLA, the smart contract deems the SLA not to have been fulfilled. The smart contract then inspects the data package size measurements it received from each data monitor along with their relative positions along the transmission path of the data package. This is to determine at which node the size of the data package changed. For example, if data monitors 11 and 12 each measure a value of 100 MB, and data monitors 13 and 14 each measure a value of 80 MB, the smart contract 50 determines that the size of the data package changed from 100 MB to 80 MB while passing between data monitors 12 and 13, i.e. within the telecomms network 3. The smart contract 15 then instructs enforcement module 50 to inform the telecomms network 3 of this fact and to take remedial action.

If it is determined that the fault lies with the publisher 2, the smart contract reviews the terms of the SLA to determine the consequences of failing to meet the terms of the SLA. In this example, the SLA stipulates that the consequence is that the publisher must pay a financial penalty to the customer. The smart contract 15 instructs an enforcement module 50, to deduct the relevant financial penalty from the publisher's account and transfer it to the customer's account. The enforcement module 50 performs then does so.

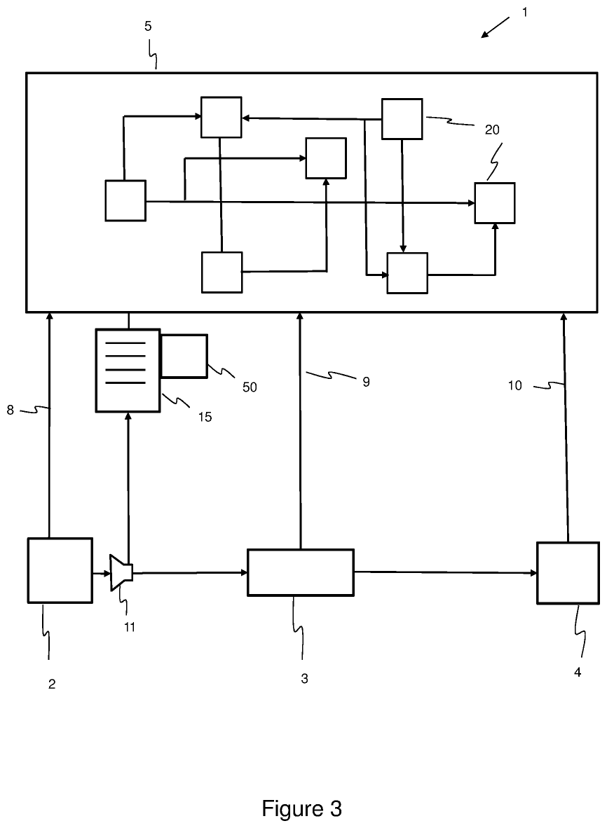

The smart contract 15 is a blockchain component and so is independent of the parties to the contract. The size of the package is therefore measured independently from the parties to the contract. The parties can therefore have confidence that the requirements of the contract have been met. FIG. 3 is a flow chart showing the above-mentioned method.

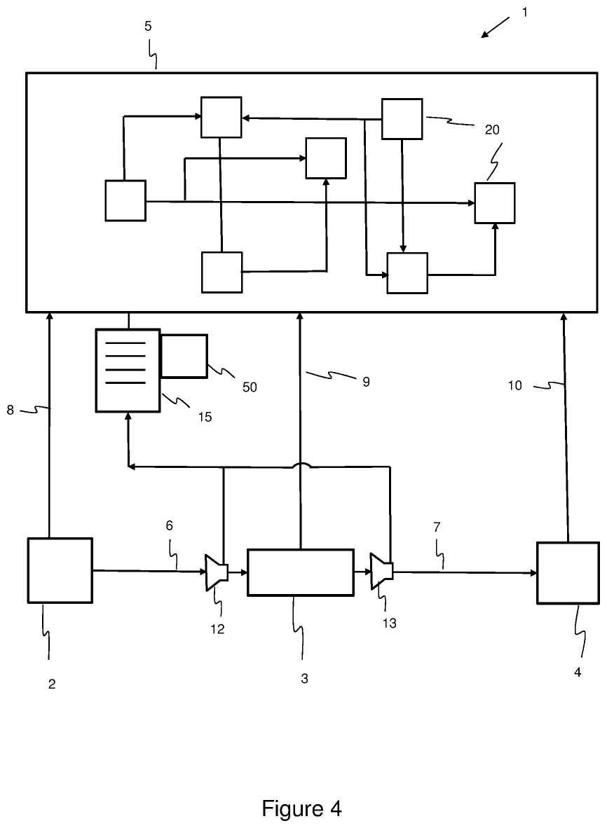

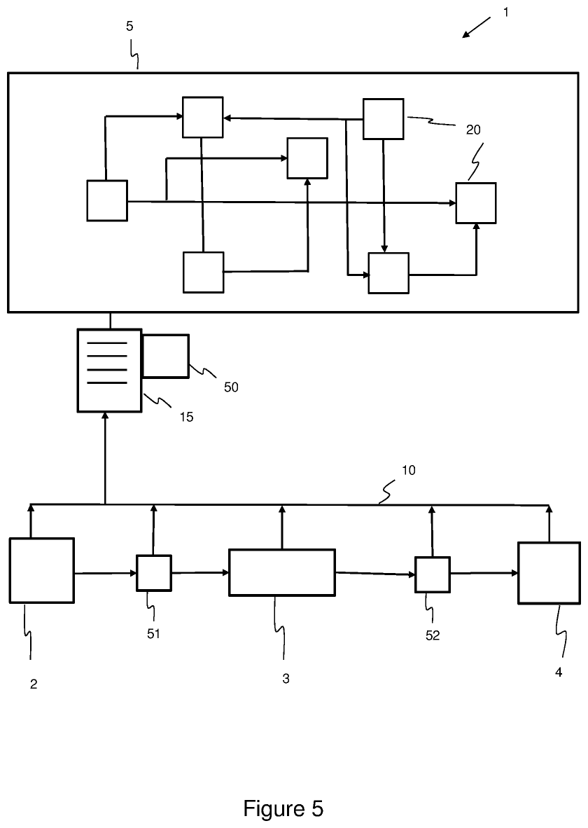

In some embodiments only one of the parties has an associated data monitor. Such embodiments are beneficial if, for example, that party is trusted by the other parties. Such embodiments are shown at FIGS. 4 and 5. In FIG. 4 it is the data publisher 2 which is the trusted party and has a data monitor 11 at its output. The data monitor is a simple data package size inspector. In this embodiment the data publisher 2 is trusted because it provides transparency, including by providing regular bill updates to the receiver 4.

In FIG. 4 it is the telecommunications network 3 which is the trusted party and has a data monitor 12 at its input and a further data monitor 13 at its output. In this embodiment the telecommunications network 3 is easily auditable by the other parties. The two data monitors 12, 13 are quality-of-package monitors.

FIG. 5 is a further embodiment according to the disclosure in which a data package is sent from a publisher 2 to a customer 4. A difference between FIG. 5 and previous embodiments is that the package also passes through further nodes 51 and 52. All of the nodes 2, 3, 4, 51, 52 send an indication of the size of the data package to the smart contract 15. The smart contract 15 receives these indications and compares them to the data package size that is stipulated by the SLA. If each of the received indications are within a given tolerance of the size stipulated by the SLA, the smart contract deems the SLA to be fulfilled and the smart contract 15 writes the transaction to the blockchain in the manner described above. If each of the received indications are not within a given tolerance of the size stipulated by the SLA, the smart contract deems the SLA not to be fulfilled. The smart contract then instructs the enforcement module to determine at which node the size of the data package changed. For example, if nodes 2, 51 and 3 each measure a value of 100 MB, and nodes 52 and 4 each measure a value of 80 MB, the enforcement module 50 determines that the size of the data package changed from 100 MB to 80 MB while passing from node 3 to node 52. The enforcement module 50 then informs the relevant parties of this fault.

1. A method of transmitting a data packet from a first node to a second node in accordance with a predetermined arrangement between a first party and a second party, the method comprising:
receiving information relating to a characteristic of the data packet at a smart contract; and
using the received information relating to the characteristic of the data packet to determine a location at which a change to the data packet occurred.

2. The method as claimed in claim 1, further comprising communicating with the location at which it is determined that the change to the data packet occurred.

3. The method as claimed in claim 1, wherein the location is a node on a transmission path of the data packet.

4. The method as claimed in claim 3, further comprising imposing a penalty on the node on the transmission path of the data packet.

5. The method as claimed in claim 1, wherein the information relating to the characteristic of the data packet is a size of the data packet.

6. The method as claimed in claim 1, wherein the change to the data packet is a reduction in a size of the data packet.

7. The method as claimed in claim 1, wherein the information is received by the smart contract from one or more data monitors.

8. The method as claimed in claim 7, wherein the one or more data monitors are blockchain components.

9. The method as claimed in claim 1, wherein the smart contract stores the transmitted information relating to the characteristic of the data packet on a blockchain associated with Distributed Ledger Technology.

10. The method as claimed in claim 1, wherein the first node and the second node define component parts of respective Internet of Things platforms.

11. A system for transmitting a data packet in accordance with a predetermined arrangement between a first party and a second party the system comprising:
a first node and a second node, the first node being adapted to transmit the data packet to the second node; and
a smart contract adapted to receive information relating to a characteristic of the data packet and to use the received information relating to the characteristic of the data packet to determine a location at which a change to the data packet occurred.
